(19) United States
(12) Patent Application Publication
(10) Pub. No.: US 2023/0264401 A1
(43) Pub. Date: Aug. 24, 2023

(54) INJECTION MOLDING MANAGEMENT DEVICE

(71) Applicant: FANUC CORPORATION, Yamanashi (JP)

(72) Inventor: Yuuki HOSOMOTO, Yamanashi (JP)

(73) Assignee: FANUC CORPORATION, Yamanashi (JP)

(21) Appl. No.: 17/999,913

(22) PCT Filed: Jul. 5, 2021
(86) PCT No.: PCT/JP2021/025281

§ 371 Date: Nov. 25, 2022

(30) Foreign Application Priority Data
Jul. 9, 2020 (JP) 2020-118166

(51) Int. Cl. B29C 45/76; B29C 45/17

(52) U.S. Cl. CPC B29C 45/76; B29C 45/1774

(57) ABSTRACT

In order to provide an injection molding management device whereby necessary information can be easily displayed, the injection molding management device according to an embodiment of the present invention comprises: a production information collection unit for collecting production information from each of a plurality of injection molding machines; a subject information extraction unit for extracting subject information selected from the production information; an information display unit for displaying the subject information in a prescribed display mode; and a selection display unit for displaying a plurality of operation images, each of which indicates a combination of the object information and the display mode, such that the operation images can be selected.

### TECHNICAL FIELD

The present invention relates to an injection molding management device.

### BACKGROUND ART

At, e.g., a factory where a plurality of injection molding machines is placed, a device that centrally controls the plurality of injection molding machines is used in some cases. Such an injection molding management device acquires various types of information from each injection molding machine so that a user can check operation states of the plurality of injection molding machines at, e.g., an operation room (see, e.g., Patent Document 1).

Patent Document 1: Japanese Patent No. 3857637

### DISCLOSURE OF THE INVENTION

### Problems to Be Solved by the Invention

In the system described in Patent Document 1, a machine list display screen for displaying information on all the injection molding machines, a group display screen for displaying information on injection molding machines belonging to a group set in advance, and a machine detail display screen for displaying information on a single injection molding machine are displayed in a switching manner. The screen can be switched using command buttons corresponding to the screens and displayed on each screen. In the system described in Patent Document 1, on the machine detail display screen, any of display forms including a quality monitor table, a trend chart, the coefficient of correlation, a distribution function, an injection molding condition, and a machine screen can be selected using another command button.

In the system described in Patent Document 1, plural steps of operation need to be performed until desired information is checked, and such a process is complicated. For this reason, there has been a demand for an injection molding management device capable of easily displaying necessary information.

### Means for Solving the Problems

The injection molding management device according to one aspect of the present disclosure includes a production information collection unit that collects production information from each of a plurality of injection molding machines, a target information extraction unit that extracts target information selected from the production information, an information display unit that displays the target information in a predetermined display form, and a selection display unit that selectively displays a plurality of operation images each indicating combinations of the target information and the display form.

### Effects of the Invention

According to the injection molding management device of one aspect of the present disclosure, the necessary information can be easily displayed.

### BRIEF DESCRIPTION OF THE DRAWINGS

FIG. 1 is a schematic view showing the configuration of a production facility including an injection molding management device according to one embodiment of the present disclosure;

FIG. 2 is a simplified view showing one display screen of the injection molding management device of FIG. 1;

FIG. 3 is a view showing a display screen different from that of FIG. 2 in the injection molding management device of FIG. 1;

FIG. 4 is a view showing a display screen different from those of FIGS. 2 and 3 in the injection molding management device of FIG. 1;

FIG. 5 is a view showing a display screen different from those of FIGS. 2 to 4 in the injection molding management device of FIG. 1;

FIG. 6 is a view showing a display screen different from those of FIGS. 2 to 5 in the injection molding management device of FIG. 1;

FIG. 7 is a view showing a display screen different from those of FIGS. 2 to 6 in the injection molding management device of FIG. 1;

FIG. 8 is a view showing a display screen different from those of FIGS. 2 to 7 in the injection molding management device of FIG. 1;

FIG. 9 is a view showing a display screen different from those of FIGS. 2 to 8 in the injection molding management device of FIG. 1;

FIG. 10 is a view showing a display screen different from those of FIGS. 2 to 9 in the injection molding management device of FIG. 1;

FIG. 11 is a view showing a display screen different from those of FIGS. 2 to 10 in the injection molding management device of FIG. 1;

FIG. 12 is a view showing a display screen different from those of FIGS. 2 to 11 in the injection molding management device of FIG. 1; and

FIG. 13 is a view showing a display screen different from those of FIGS. 2 to 12 in the injection molding management device of FIG. 1.

### PREFERRED MODE FOR CARRYING OUT THE INVENTION

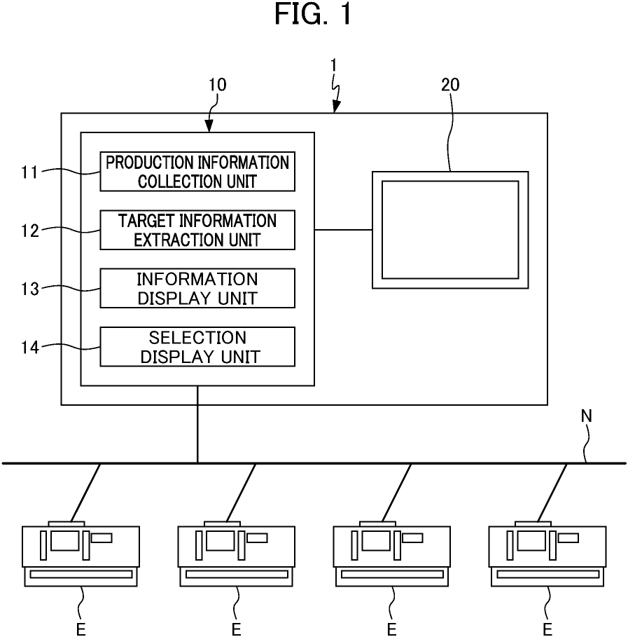

Hereinafter, an embodiment of the present invention will be described with reference to the drawings. FIG. 1 is a schematic view showing the configuration of a production facility including an injection molding management device 1 according to one embodiment of the present disclosure.

The production facility includes a plurality of injection molding machines E and the injection molding management device 1 of one embodiment of the present disclosure connected to the plurality of injection molding machines E via a communication network N.

Each injection molding machine E includes a local control device having a communication interface, and is communicable with the injection molding management device 1. The injection molding machine E may include not only an injection molding machine body, but also supplementary facilities to be integrally controlled, such as a device that supplies resin, a device that handles a molded item, and a device that inspects a molded item.

The communication network N may be an optional network such as a wired LAN including the Ethernet, a wireless LAN including the WiFi, or a public telecommunication network including a mobile network. Among these networks, the wired LAN is particularly suitably used.

The injection molding management device 1 includes a control device 10 and a display device 20. The control device 10 can be implemented in such a manner that one or more computer devices including CPUs, memories, communication interfaces, etc. read proper programs. The display device 20 may include, for example, a liquid crystal monitor, and may be integrated with the control device 10.

The control device 10 has a production information collection unit 11, a target information extraction unit 12, an information display unit 13, and a selection display unit 14. These components are the types of function of the control device 10, and are not necessarily clearly distinguishable in a mechanical structure and a program structure of the control device 10. The control device 10 may further have components that implement other functions.

The production information collection unit 11 collects production information from each of the plurality of injection molding machines E. The production information collected from the injection molding machines E includes, for example, an identification mark for the injection molding machine E, an identification mark for a product to be produced or a molding condition applied to the product to be produced, an operation state (a status such as automatic operation, manual operation, alarming stop, or operation stop), the number of non-defective items (the number of shots), and a power consumption. Such production information is preferably collected as information for every hour.

The target information extraction unit 12 extracts target information selected from the production information. The target information is preferably selected based on at least any one of the identification mark for the injection molding machine E and the identification mark for the product to be produced by the injection molding machine E or the molding condition. That is, a search formula for extracting the target information preferably specifies at least one of the identification mark for the injection molding machine E and the identification mark for the product (the molding condition). For extraction of the target information, other search criterion may be set in addition to at least one of the identification mark for the injection molding machine E and the identification mark, etc. for the product (the molding condition).

Specifically, the target information may be plural pieces of time-series data on the operation state, the number of non-defective items, the power consumption, etc. of a single injection molding machine E, plural pieces of time-series data on the operation state, the number of non-defective items, the power consumption, etc. of a single product (molding condition), time-series data only on an operation status of a group of a plurality of injection molding machines E, and data on the current operation state, the current number of non-defective items, the current power consumption, etc. of all the injection molding machines E.

The production information to be checked varies according to a target for management by a user and a purpose for management by the user, and it is not efficient to provide all pieces of production information to all users. For this reason, the target information is preferably a production information group that can be efficiently checked by the user at once, and different pieces of target information may be set according to a user attribute such as a user type including a corporate manager, a production facility manager, a facility maintenance manager, and a mold manager. Specifically, in a case where the purpose is management of the entirety of the production facility, an operation rate, an operation time, a production number, a power consumption, etc. need to be grasped in consideration of the entirety of the production facility. In a case where the purpose is maintenance of the injection molding machine E, an operation rate and an operation time for each injection molding machine E need to be grasped. In the case of performing production management, a production number not for each injection molding machine E but for each product (molding condition) needs to be grasped.

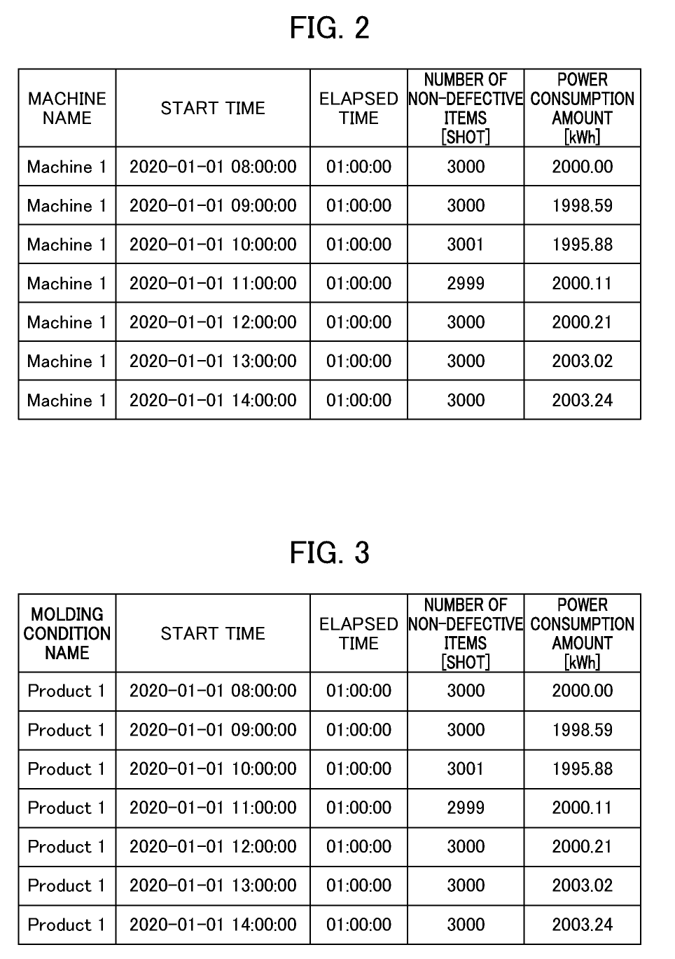

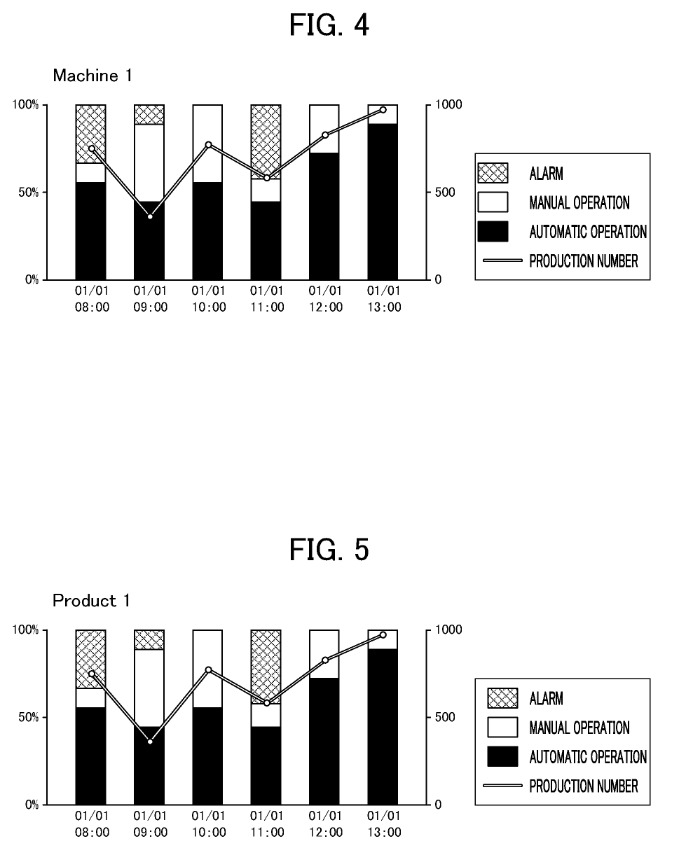

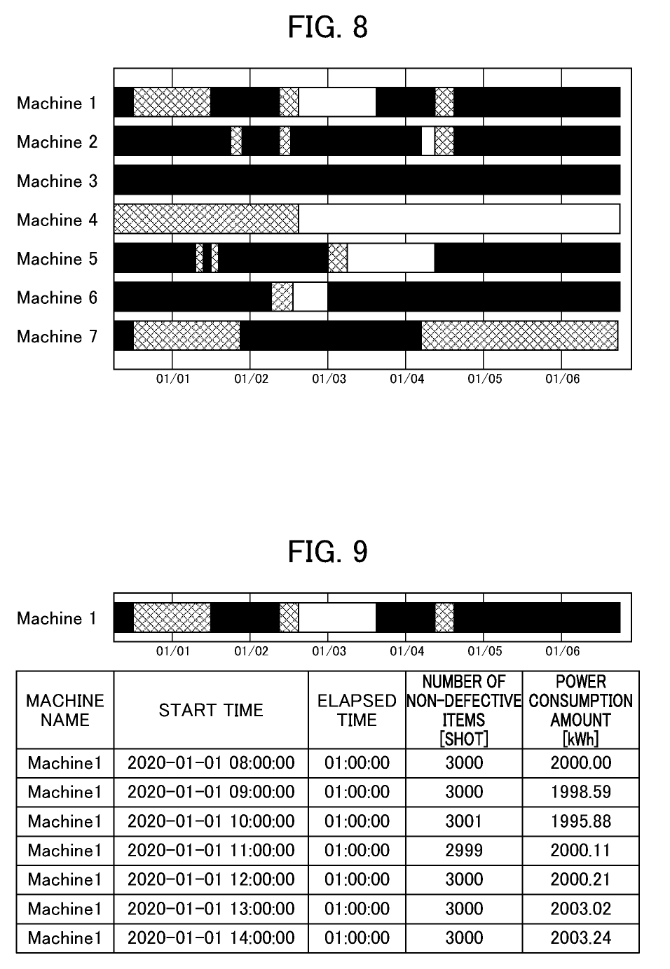

The information display unit 13 displays the target information in a predetermined display form on the display device 20. The display form displayed by the information display unit 13 may include at least any one of a list, a graph, and a time chart. For example, the list may show, by characters (including numbers and symbols), plural pieces of production information on a single injection molding machine E or product (molding condition), as shown in FIGS. 2 and 3. The graph may be a bar graph, a line graph, etc. showing a time change in the production information, which can be represented by numerical values, on one or more injection molding machines E or products (molding conditions), as shown in FIGS. 4 to 7. The time chart may show transition of the operation state, etc., which cannot be represented by numerical values, of one or more injection molding machines E over time, as shown in FIG. 8. For example, the display form displayed by the information display unit 13 may include plural ones of the list, the graph, and the time chart, as shown in FIG. 9. The display form displayed by the information display unit 13 may include displayed information other than the list, the graph, and the time chart.

The display form displayed by the information display unit 13 may include at least any one of an operation rate, an operation time, a production number (an integrated value of the number of non-defective items), and a power consumption amount (an integrated value of a power consumption) calculated from the target information.

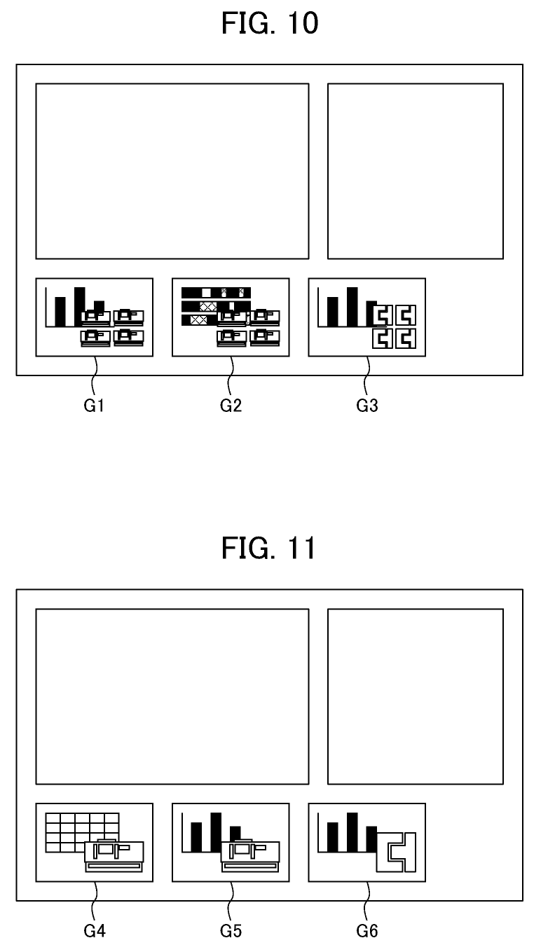

As shown in FIGS. 10 to 13, the selection display unit 14 selectively displays, on the display device 20, a plurality of operation images G1 to G8 each indicating a combination of the target information and the display form. The selection display unit 14 preferably selectively displays the operation images G1 to G8 indicating a part of the combinations of the target information and the display form other than combinations which are possible in theory, but are less useful in being provided to the user. For example, the selection display unit 14 more preferably selects the operation images G1 to G8 to be displayed according to the user attribute specified by, e.g., a login ID or selection on the screen.

The operation images G1 to G8 displayed by the selection display unit 14 are preferably displayed in the form of an icon so that the user can easily recognize the combination of the target information and the display form. The operation images G1 to G8 shown as examples in FIGS. 10 to 13 are displayed such that an image indicating the target information is on an image indicating the display form. The operation images G1 to G8 may include, for example, minimum character information, such as an identification mark, indicating a group of injection molding machines E included in the target information. In the shown examples, images to be used as the image indicating the target information include an image indicating a single injection molding machine E, an image indicating a single product (molding condition), an image indicating a plurality of injection molding machines, and an image indicating a plurality of products (molding conditions). Images to be used as the image indicating the display form include an image indicating a list, the image indicating a graph, an image indicating a time chart, and an image indicating a combination of a time chart and a list.

Not only does the production information to be checked vary according to the target for management by the user and the purpose for management by the user, but also the optimal display form of the production information varies according to the target for management by the user and the purpose for management by the user. For example, in a case where the user is a corporate manager, visibility is considered to be important so that the entire information can be generally grasped, and there is a demand for easy understanding of a rough trend by a graph. On the other hand, in a case where the necessity of maintenance of the production facility is determined or a case where improvement is made to enhance productivity, a list including character information from which detailed numerical values or times can be specified is preferably used in some cases.

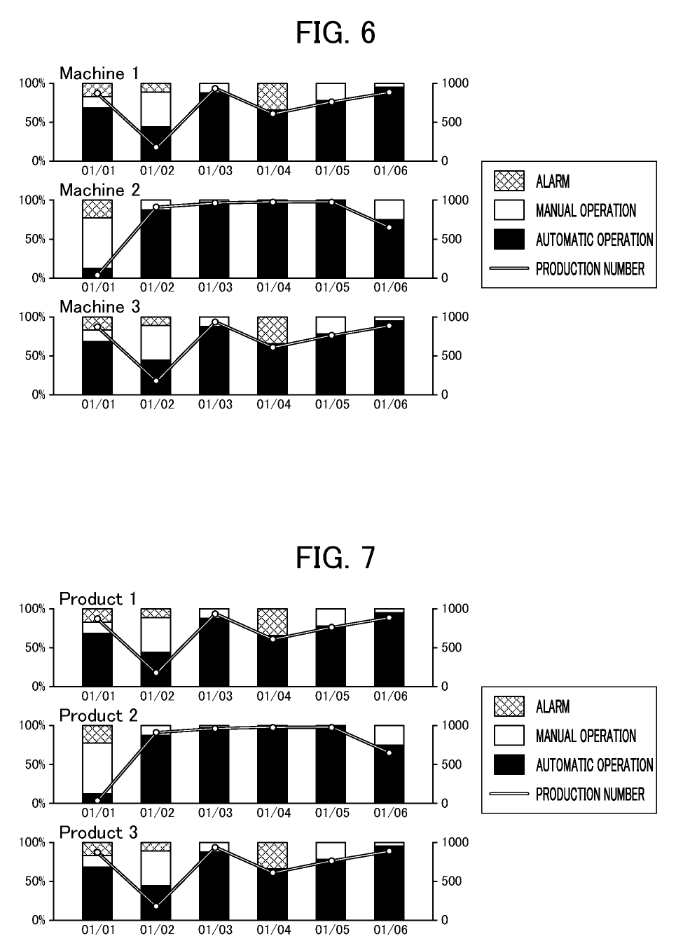

As a specific example, in a case where the user is the corporate manager, the selection display unit 14 may display, as shown in FIG. 10, the first operation image G1 transitioning to the screen (FIG. 6) for displaying an operation state of each of a plurality of injection molding machines E per unit time (an elapsed time in the figure) in the form of a graph, the second operation image G2 transitioning to the screen (FIG. 8) for displaying an operation state of each of a plurality of injection molding machines E in the form of a time chart, and the third operation image G3 transitioning to the screen (FIG. 7) for displaying a production number and an operation state of each of a plurality of products (or each molding condition) per unit time (an elapsed time in the figure) in the form of a graph, these first to third operation images G1 to G3 being useful for grasping the operation state of the entirety of the production facility.

In a case where the user is a production manager, the selection display unit 14 may display, as shown in FIG. 11, the fourth operation image G4 transitioning to the screen (FIG. 2) for displaying a list of operation information, the number of non-defective items, etc. for a single injection molding machine E, the fifth operation image G5 transitioning to the screen (FIG. 4) for displaying a graph of a production number and an operation state of a single injection molding machine E per unit time (an elapsed time in the figure), and the sixth operation image G6 transitioning to the screen (FIG. 5) displaying a graph of a time-series change in a production number and an operation state of a single product (the type of molding condition), these fourth to sixth operation images G4 to G6 being useful for grasping the progress of production.

The selection display unit 14 may have a function of selecting the target information to be displayed by selection of the operation image G4, i.e., an injection molding machine E or a product to be displayed, according to the frequency of use, the type of product, a latest operation state, etc. As an example, the selection display unit 14 may take, as the target information, production information on an injection molding machine E producing a great number of the same product as a currently-produced product within a certain latest period. In such a case, the selection display unit 14 may additionally display character information specifying the target information selected as the operation image G4, and for example, may display a plurality of operation images G4 on which character information is added to each piece of target information with a higher number of productions.

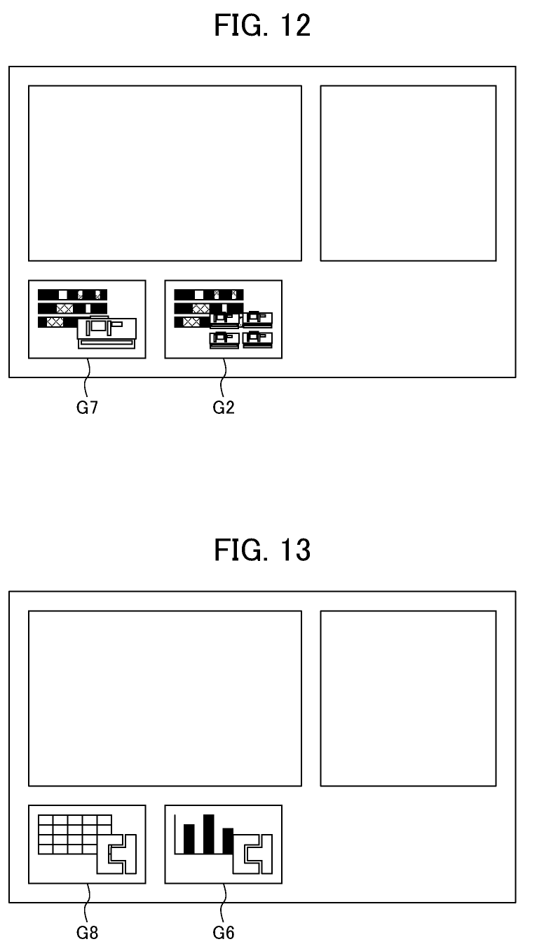

In a case where the user is a maintenance manager for the injection molding machine E, the selection display unit 14 may display, as shown in FIG. 12, the seventh operation image G7 transitioning to the screen (FIG. 9) for displaying a time chart showing a time-series change in an operation state of a single injection molding machine E and a list of an operation state of the injection molding machine E for every hour and the second operation image G2 transitioning to the screen (FIG. 8) for displaying a time-series change in an operation state of each of a plurality of injection molding machines E in the form of a time chart, these seventh and second operation images G7, G2 being useful for grasping a maintenance period for the injection molding machine.

In a case where the user is a mold manager, the selection display unit 14 may display, as shown in FIG. 13, the eighth operation image G8 transitioning to the screen (FIG. 3) for displaying a list of an operation time, the number of non-defective items, etc. under a single molding condition and the sixth operation image G6 transitioning to the screen (FIG. 5) for displaying a graph of a time-series change in numerical values of an operation time and a production number under a single molding condition, the eighth and sixth operation images G8, G6 being useful for grasping the life of a mold.

As described above, the selection display unit 14 displays the plurality of operation images G1 to G8 indicating the combinations of the target information and the display form so that the user can check necessary information in a simple display form by less operation. On the other hand, in a typical injection molding management device, a process is complicated because it is necessary to sequentially specify a display form and production information to be displayed.

The combinations, which are possible in theory, of the production information and the display form include many which have limited value as information. The unnecessary combinations of the production information and the display form include the list of the production information on all the injection molding machines E. For example, a corporate manager needs to grasp a whole picture of manufacturing by the production facility. However, even if all pieces of information are displayed by characters, the whole picture cannot be easily grasped because the amount of information is too great and readability is low. The same also applies to displaying the list of all the products, and such a list is not suitable for, e.g., grasping the progress of production of an individual product or predicting the life of the mold. There is a case where the frequency of operation under a single molding condition is low. Even if a time chart of an operation state under a single molding condition or all other molding conditions is displayed, only a non-use state is noticeable, and an operation time necessary for predicting the life of an individual mold or determining inspection timing cannot be properly grasped.

However, in the injection molding management device 1 of the present embodiment, the selection display unit 14 displays only the operation images G1 to G8 to display the combinations of the production information (the target information) and the display form necessary for the user. Thus, not only is the user’s operation facilitated, but also programs for unnecessary combinations of the production information and the display form are not necessary. Consequently, a simple program can be used.

The embodiment of the injection molding management device according to the present disclosure has been described above, but the scope of the present disclosure is not limited to the above-described embodiment. The advantageous effects described above in the embodiment are merely listed as most suitable advantageous effects of the injection molding management device according to the present disclosure, and the advantageous effects of the injection molding management device according to the present disclosure are not limited to those described above in the embodiment.

As an example, the injection molding management device according to the present invention may specify the target information based on an attribute other than an injection molding machine and a product (molding condition).

EXPLANATION OF REFERENCE NUMERALS

| | |
|---|---|
| 1 | Injection Molding Management Device |
| 10 | Control Device |
| 11 | Production Information Collection Unit |
| 12 | Target Information Extraction Unit |
| 13 | Information Display Unit |
| 14 | Selection Display Unit |
| 20 | Display Device |
| E | Injection Molding Machine |
| G1 to G8 | Operation Image |
| N | Communication Network |

1. An injection molding management device comprising:
a production information collection unit that collects production information from each of a plurality of injection molding machines;
a target information extraction unit that extracts target information selected from the production information;
an information display unit that displays the target information in a predetermined display form; and
a selection display unit that selectively displays a plurality of operation images each indicating combinations of the target information and the display form.

2. The injection molding management device according to claim 1, wherein the target information is selected based on at least any one of an identification mark for each injection molding machine and an identification mark for a product to be produced by each injection molding machine or a molding condition applied to a product to be produced.

3. The injection molding management device according to claim 1, wherein the display form includes at least any one of a list, a graph, and a time chart.

4. The injection molding management device according to claim 1, wherein the display form includes at least any one of an operation rate, an operation time, a production number, and a power consumption amount calculated from the target information.

5. The injection molding management device according to claim 1, wherein the selection display unit displays only operation images indicating a part of the combinations.
